(19) United States
(12) Patent Application Publication
(10) Pub. No.: US 2008/0146107 A1
(43) Pub. Date: Jun. 19, 2008

(54) STRETCHABLE SCRIM WRAPPING MATERIAL

(75) Inventors: Martin Vido, Mission (CA); Timothy A. Williams, South Elgin, IL (US); Manish K. Seth, Mission (CA)

Correspondence Address: KIRTON AND MCCONKIE, 60 EAST SOUTH TEMPLE,, SUITE 1800, SALT LAKE CITY, UT, 84111, US

(73) Assignees: INTERWRAP INC., Mission (CA); IBCO SRL, St. Michael (BB)

(21) Appl. No.: 11/950,972

(22) Filed: Dec. 5, 2007

Related U.S. Application Data
(60) Provisional application No. 60/868,650, filed on Dec. 5, 2006.

(51) Int. Cl. B32B 5/26; B32B 7/00

(52) U.S. Cl. 442/36; 442/35

(57) ABSTRACT

An industrial packaging material comprises a woven scrim of stretchable thermoplastic tapes bonded to a stretchable non-woven water-impermeable layer. The scrim and the non-woven layer are made from a blend comprising a polyolefin and an elastomer. The thermoplastic tapes of the scrim have a degree of elongation before breaking in the range of 20% to 500%.

### CROSS-REFERENCE TO RELATED APPLICATION

This application claims the benefit of provisional application No. 60/868,650, filed Dec. 5, 2006.

### TECHNICAL FIELD OF THE INVENTION

The invention pertains to packaging materials for the protection of products such as pieces of steel and wood.

### BACKGROUND OF THE INVENTION

It is known in the industrial packaging field to provide wrapping materials comprising a scrim made of woven plastic tapes. Such wrapping materials are used for wrapping lumber, steel and other industrial products, for purposes of storage and shipping. Such materials typically have little capacity to flex or adhere tightly to the wrapped goods.

### SUMMARY OF THE INVENTION

The invention is a wrapping material, suitable for wrapping or holding a product to protect it from abrasion and damage during shipping and storage. The material comprises a sheet, strip or bag of wrapping material that includes a plastic scrim made of stretchable tapes. The property of stretchability of the wrapping material permits the wrapped product to bend or flex during transport without causing rupture of the packaging material. The wrapping material comprises a woven scrim of stretchable thermoplastic tapes bonded to a stretchable non-woven, water-impermeable layer. The tapes of the scrim have a degree of elongation before breaking in the range of 20% to 500%. The tapes comprise a blend comprising a polyolefin resin and an elastomer. The non-woven layer also comprises a blend comprising a polyolefin resin and an elastomer.

According to a further embodiment of the invention, the wrapping material includes a second stretchable non-woven, water-impermeable layer bonded to the scrim and comprising a blend of a polyolefin and an elastomer. Optionally, the wrapping material may include a bonding layer between the scrim and the respective two non-woven layers, the bonding layers having a rate of elongation that is different from the rate of elongation of the non-woven layers.

According to a further embodiment of the invention, the material comprises a woven scrim of stretchable thermoplastic tapes, without any non-woven layer.

### BRIEF DESCRIPTION OF THE DRAWINGS

FIG. 1 is a cross-sectional view across the width of a strip of the packaging material according to one embodiment of the invention.

FIG. 2 is a cross-sectional view of a second embodiment.

FIG. 3 is a cross-sectional view of a third embodiment.

### DETAILED DESCRIPTION OF THE PREFERRED EMBODIMENTS

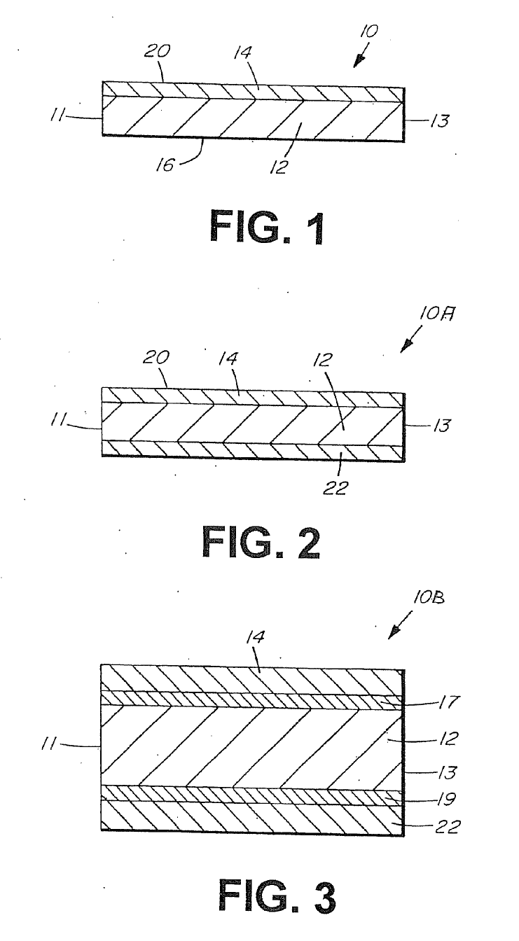

FIGS. 1 to 3 show preferred embodiments of the wrapping material. Corresponding and like parts are referred to in the following description and indicated in the drawings by the same reference characters. The drawings are not to scale and exaggerate the thickness of the layers for clarity of illustration.

According to a first embodiment of the invention, shown in FIG. 1, the wrapping material 10 comprises a woven layer 12, i.e. a scrim, laminated to a non-woven layer 14. The strip of material 10 has opposed longitudinal edges 11, 13.

The woven layer 12 is formed of stretchable plastic tapes made of polyolefin material, such as polyethylene, polypropylene, thermoplastic olefins, or blends thereof. The tapes may incorporate volatile corrosion inhibitors. Elastomers are included in the resin blends used to form the tapes, in the range of about 3% to 40% by weight. Suitable elastomers include KRATON (trademark) polymers sold by Kraton Polymers LLC, and TPO-type products. The tapes have a degree of elongation before breaking in the range of 20% to 500%. Recovery of the tapes after elongation is in the range of about 10% to 90%, depending on the extent of elongation of the tapes.

The stretchability of the tapes of the scrim 12 can be controlled by means of the level of elastomers used in the resin blend and by means of the processing parameters in the extrusion process used to manufacture the tapes.

In weaving the plastic tapes to form the scrim, the tapes are not to be crushed or locked to each other, in either the machine direction or the cross-direction, to avoid reducing the stretchability of the scrim. In order to permit the tapes to stretch freely, it is preferred to use a reinforcing structure including 0 to 10 tapes per inch in the machine direction and/or 0 to 10 tapes in the cross direction, or continuations thereof. Examples include 4×2, 4×3, 4×4, 5×2, 5×3, and 5×4.

The non-woven layer 14 is a film of water-impermeable plastic. It may optionally also be either air- and water vapor-impermeable, or air- and water vapor-permeable, having, for example, a permeability in the range of 2 to 80 perms. The non-woven layer 14 comprises polyolefin material such as polyethylene (LDPE or LLDPE) or polypropylene, or blends thereof, blended with an elastomer and with tackifier additives. It preferably comprises a blend of LDPE, LLDPE and an elastomer. The preferred level of LLDPE is 10% to 70% by weight. The preferred level of elastomer is 3% to 40% by weight.

The non-woven layer is sufficiently stretchable that fracture and deformation of the material is avoided when the material is stretched. The non-woven layer 14 preferably has the same properties of stretchability as the woven layer 12, as described above. It is preferably made of the same materials and additives as the tapes.

The purpose of the non-woven layer 14 is principally to maintain the integrity of the woven layer and impart a waterproof outer coating to the wrapping material.

The non-woven layer 14 can be bonded to the woven layer 12 by any conventional method, for example by lamination, heat sealing, adhesives, or by direct extrusion onto the woven layer.

In another embodiment of the invention, the wrapping material comprises simply the woven layer 12. Such wrapping material can be used for applications not requiring protection against moisture for the wrapped product.

Referring next to FIG. 2, the wrapping material of the invention may include one or more additional layers, such as a layer of kraft paper or a second layer of synthetic polymeric material or non-woven material (for example Spunbond Polypropylene PP). The wrapping material 10A incorporates one such additional polyolefin film layer 22. The scrim 13 is thus laminated to a film layer on both sides. The polyolefin layer 22 preferably has the same composition and properties as the non-woven layer 14. In alternative configurations of the wrapping material, the scrim is laminated (or otherwise bonded) on one or both sides to a non-woven layer, a paper layer, a plastic film or other substrate, or combinations thereof.

FIG. 3 shows a further embodiment of the wrapping material, in which the wrapping material 10B includes layers 14 and 22 bonded to the woven layer 12 by means of bonding layers 17 and 19 respectively. The bonding agent of the layers 17, 19 has a different elongation rate than the layers 14 and 22. Layers 14 and 22 are more stretchable than bonding layers 17 and 19. This difference allows the non-woven layers 14 and 22 to move independently from each other and from the woven layer 12 during the application of the packaging material to a product, enhancing the packaging sealability and its ability to protect the wrapped product. This independent movement of the layers may be achieved either by the fracturing of the bonding agent or by its complete separation from the woven layer 12 and non-woven layers 14 and 22 when the wrapping material is under stress. The bonding agent is a polyolefin layer acting as a laminating agent. Alternatively, all the layers of the wrapping material 10B may have the same stretch ratio.

The wrapping materials 10, 10A and 10B have a tensile strength in the range of 5 kg to 30 kg and a tear strength in the range of 4 kg to 25 kg, in both the machine and cross directions. The tensile strength and tear strength can be selected by means of the degree of elongation of the tapes, the type of scrim construction and the coating weights used during lamination.

The wrapping material of the invention may be made in any convenient form for use in wrapping a particular article. It can be made in the form of strips, for example in the order of seven to twelve inches wide, for wrapping in an overlapping manner on a product. It can be made in the form of large sheets. Such strips and sheets can be wound onto a roll for use and dispensing. The wrapping material can also be made into bags for holding a product.

What is claimed is:

1. A wrapping material comprising:
(a) a woven scrim of stretchable thermoplastic tapes, said tapes having a degree of elongation before breaking in the range of 20% to 500%, said tapes comprising a blend comprising a polyolefin and an elastomer; and
(b) a stretchable non-woven, water-impermeable layer bonded to said scrim, said non-woven layer comprising a blend comprising a polyolefin and an elastomer.

2. A wrapping material according to claim 1, wherein said tapes have a degree of recovery after elongation in the range of 10% to 90%.

3. A wrapping material according to claim 1, wherein said elastomer in said tapes comprises 3% to 40% by weight of said tapes.

4. A wrapping material according to claim 1, wherein said elastomer in said non-woven layer comprises 3% to 40% by weight of said tapes.

5. A wrapping material according to claim 1, wherein said scrim comprises a reinforcing structure having from 0 to 10 tapes per inch in a machine-direction or 0 to 10 tapes per inch in a cross-direction, or combinations thereof.

6. A wrapping material according to claim 1, wherein said polyolefin of said tapes comprises polyethylene, polypropylene, thermoplastic olefin, or blends thereof.

7. A wrapping material according to claim 1, wherein said polyolefin of said non-woven layer comprises polyethylene or polypropylene, or blends thereof.

8. A wrapping material according to claim 1, wherein said polyolefin in said non-woven layer comprises 10% to 70% by weight LLDPE.

9. A wrapping material according to claim 1, wherein said wrapping material has a tensile strength in the range of 5 to 30 kg, in a machine direction and a cross direction.

10. A wrapping material according to claim 1, wherein said non-woven layer has a degree of elongation before breaking in the range of 20% to 500%.

11. A wrapping material according to claim 1, further comprising a second stretchable non-woven, water-impermeable layer bonded to said scrim, said second non-woven layer comprising a blend comprising a polyolefin and an elastomer.

12. A wrapping material according to claim 1, wherein said wrapping material has a tear strength in the range of 4 to 25 kg, in a machine direction and a cross direction.

13. A wrapping material according to claim 1, wherein said non-woven layer is air-impermeable and water vapor-impermeable.

14. A wrapping material according to claim 1, wherein said non-woven layer is air-permeable and water vapor-permeable.

15. A wrapping material according to claim 14, wherein said permeability is in the range of 2 to 80 perms.

16. A wrapping material according to claim 1, further comprising a layer of kraft paper bonded to said scrim.

17. A wrapping material according to claim 1, further comprising:
(c) a second stretchy non-woven, water-impermeable layer bonded to said scrim, said second non-woven layer comprising a blend comprising a polyolefin and an elastomer; and
(d) a bonding layer between said scrim and said respective two non-woven layers, said bonding layers having a rate of elongation that is different from a rate of elongation of said non-woven layers.

18. A wrapping material comprising a woven scrim of stretchable tapes, said tapes having a degree of elongation before breaking in the range of 20% to 500%, said tapes comprising a blend comprising a polyolefin and an elastomer.
